(19) United States
(12) Patent Application Publication
(10) Pub. No.: US 2024/0416624 A1
(43) Pub. Date: Dec. 19, 2024

(54) A FIBRE-METAL COMPOSITE PANEL COMPRISING A FIBRE-REINFORCED THERMOPLASTIC PANEL AND A METAL PLATE, AND A METHOD FOR MANUFACTURING IT

(71) Applicants: Jan VERHAEGHE, Haasdonk (BE); Koen DE ROEVE, Berlare (BE)

(72) Inventors: Jan VERHAEGHE, Haasdonk (BE); Koen DE ROEVE, Berlare (BE)

(21) Appl. No.: 18/722,973

(22) PCT Filed: Dec. 19, 2022
(86) PCT No.: PCT/IB2022/062484

§ 371 Date: Jun. 21, 2024

(30) Foreign Application Priority Data
Dec. 22, 2021 (BE) BE2021/6032

(51) Int. Cl. B32B 15/14; B32B 5/02; B32B 7/12; B32B 15/18; B32B 15/20; B32B 37/12; B32B 38/08

(52) U.S. Cl. CPC B32B 15/14; B32B 5/024; B32B 7/12; B32B 15/18; B32B 15/20; B32B 37/12; B32B 38/08; B32B 2255/06; B32B 2255/10; B32B 2255/26; B32B 2260/023; B32B 2260/046; B32B 2262/101; B32B 2305/07; B32B 2305/08; B32B 2307/7376; B32B 2309/02; B32B 2309/12; B32B 2605/18

(57) ABSTRACT

A fibre-metal composite panel is formed from a thermoplastic panel and a metal plate, in which the thermoplastic panel and the metal plate are bonded using a chemical crosslinking agent, and the thermoplastic panel is fibre-reinforced. The chemical crosslinking agent has a thermoplastic polyurethane elastomer. Furthermore, a multilayer fibre-metal composite panel and a structural part for a vehicle are provided. A method is provided for manufacturing the fibre-metal composite panel and the multilayer fibre-metal composite panel.

### TECHNICAL FIELD

The invention is situated in the domain of the plastic composites, more in particular plastic composite panels. The invention is especially interesting for applications in which a combination of strength and lightweight are important, such as for example in the transport industry and aviation.

### BACKGROUND

A composite element is a material that is made up of several components with different physical or chemical characteristics which, in combination, provide an element with characteristics which are different from the individual components. Composite elements are used for replacing traditional materials such as glass, steel, aluminium and wood. Examples of composite elements are fibres combined with plastic. The assembling of fibres with a plastic material can provide a material which stays lightweight and yet is very strong and stiff. Another example is the combination of a layer of plastic material with a layer of foamed plastic for forming layered plastic elements. They have a good thermal insulation and are lightweight.

Several techniques are well-known for combining plastic materials such as laminating, welding, gluing or stitching. Working with different layers is often aimed at reinforcing the composite element in three directions, length-width-height.

When laminating, the contact surfaces of the layers to join are heated and pressed into each other, wherein the materials which have plasticized, merge together. When cooling down, the materials become hard, and they are joined physically.

Welding is the joining of materials by pressure and/or heat, where the material is brought into a liquid state at the joining point, creating continuity between the parts to be joined.

Lamination and welding are joining techniques which consume quite a lot of energy. They are preferably applied for joining two identical materials. The heating of materials is not appropriate for temperature-sensitive materials. There is a risk of charring of materials.

When gluing, a material is used which sticks or adheres to the materials to be joined. When gluing, the materials to join do not have to be heated. However, panels made of foamed cores between two fibre-reinforced plastic layers, which are glued to the foamed core, have delamination problems when subjected to mechanical stress.

When stitching, materials are secured an in-and-out movement with a thread or rope. EP1506083 for example discloses a 3D reinforced composite element consisting of a sandwich of a core material inserted between two fibre-reinforced layers, wherein the layers are secured by tufting an essentially continuous fibre-reinforced material through the different layers, followed by an impregnation of the laminate with a liquid plastic, and curing of the plastic upon cooling. It is not obvious to pierce panels by means of a needle and thread for tying them up with stitches. The process of obtaining liquid plastic, requires heating above the melting temperature of the plastic. It requires a lot of energy. The plastic which has been melted, is applied as an outer layer on top of a layer of fibre-reinforced plastic. With a high degree of reinforcement, and consequently a large presence of fibres, the fibres can form a physical barrier that hinders penetration of the molten plastic.

Composite panels that were introduced in aircraft construction are laminates made of metal sheets and wires. The parts are joined using a metal glue. Composite panels as described in NL8100087 and NL8100088, are known as GLARE or GLAss REinforced aluminium. Its production is cumbersome and expensive.

Consequently, there is a need for further alternatives and improvements.

The present invention aims to solve one or more of the above-mentioned problems. The invention aims to provide a composite panel that is strong and lightweight. The invention aims to offer a fibre-reinforced metal-composite panel with high resistance to delamination. The invention also aims to offer a process which is economically relevant. Also, the invention aims to provide uses in the transportation sector.

### SUMMARY OF THE INVENTION

Thereto, the invention provides a fibre-metal composite panel and a multilayer fibre-metal composite panel. Also, the invention provides some uses for these composite panels, namely as a structural part for a vehicle.

The invention also provides a method for manufacturing the composite panels of the invention.

Finally, the invention provides panels manufactured using the method of the invention.

Further preferred embodiments have been described in the dependent claims.

### DESCRIPTION OF THE FIGURES

FIG. 1 shows a schematic illustration of a fibre-metal composite panel according to a preferred embodiment of the invention.

### DETAILED DESCRIPTION OF THE INVENTION

Unless otherwise specified, all terms used in the description of the invention, including technical and scientific terms, shall have the meaning as they are generally understood by the worker in the technical field the present invention relates to. Furthermore, definitions of the terms have been included for a better understanding of the description of the present invention.

As used here, the following terms shall have the following meaning: “A”, “an” and “the”, as used here, refer to both the singular and the plural form unless clearly understood differently in the context. For example, “a compartment” refers to one or more than one compartment.

“Approximately” as used here, that refers to a measurable value such as a parameter, a quantity, a period or moment, etc., is meant to include variations of +/−20% or less, preferably +/−10% or less, more preferably +/−5% or less, still more preferably +/−1% or less, and even still more preferably +/−0.1% or less of the cited value, as far as such variations are appropriate for realizing the invention that is described. It will however be clear that the value to which the term “approximately” relates, will also be described specifically. The terms “include”, “including” and “included”, as used here, are synonym with “comprise”, “comprising” and “comprises” and are inclusive of open terms that indicate the presence of what follows e.g. a component, and that do not exclude the presence of additional, non-said components, characteristics, elements, members, steps, that are well-known from or described in the state of the art.

The citation of numeric intervals by means of end points includes all integers and fractions included within that interval, including these end points.

The invention provides a solution for reducing the cost of fibre-metal composite panels. The production of the panels is simpler. The invention provides a solution for improving the adhesion of metal-plastic surfaces. The invention provides panels with resistance to delamination. The resistance to delamination is preferably both at a static and at a dynamic load of a composite panel according to an embodiment of the invention.

In a first aspect, the invention provides a fibre-metal composite panel formed from a thermoplastic panel and a metal plate, characterized in that the thermoplastic panel and the metal plate are bonded using a chemical crosslinking agent, and the thermoplastic panel is fibre-reinforced.

Preferably, the thermoplastic panel comprises at least one fibre substrate and at least one thermoplastic polymer P1 coupled to the fibre substrate. The fibre substrate is preferably a glass fibre substrate; more preferably a woven fibreglass mat.

The coupling can be obtained as described in EP2813533. This involves (a) contacting glass fibres with a sizing composition for sizing glass fibres, (b) assembling the sized glass fibres into a glass fibre substrate, and (c) contacting the glass fibre substrate with a thermoplastic polymer, (d) chemically coupling the thermoplastic polymer and the glass fibre substrate.

Preferably the chemical crosslinking agent comprises:
c1) a thermoplastic polymer P2 having at least one functional group r_{c}), in which thermoplastic polymer P2 is a thermoplastic polyurethane elastomer,
c2) a monomer or oligomer with at least two reactive functional groups r_{d1}), r_{d2}),
in which r_{d1}) and r_{d2}) are selected for reactivity with
a functional group rₐ) of the thermoplastic panel,
a functional group r_{b}) of the metal plate and
a functional group r_{c}) of the thermoplastic polymer P2 in the chemical crosslinking agent.

In the chemical crosslinking agent, the functional group r_{c}) is preferably equal to or different from said functional groups rₐ) and/or r_{b}). More preferably r_{d1})=r_{d2}).

The term “thermoplastic polymer”, as used herein, is a collective term for plastics; preferably polyurethanes, polyamides or polyesters; solidifying at 25° C. and softening when heating them. The thermoplastics have the advantage that they are recyclable.

In a fibre-metal composite panel according to an embodiment of the invention, the thermoplastic polymer in the chemical crosslinking agent is a thermoplastic elastomer.

The term elastomer, as used herein, denotes polymers with rubbery characteristics. An elastomer is elastic under moderate tension. An elastomer has a relatively high tensile strength and memory, so that the elastomer, when removing the tension, returns to its original dimensions which are practically comparable to its original dimensions.

Thermoplastic elastomers (TPE) refer to materials having both thermoplastic and elastomer characteristics. The elastomer characteristic ensures a good dynamic loading capacity of the composite element obtained according to the method. The hardness of the thermoplastic elastomers is preferably situated between 20 Shore A and 80 Shore A.

The thermoplastic elastomer used in the present invention is a thermoplastic polyurethane elastomer.

A polyurethane is composed of a molecule having several isocyanate (—N═C═O) functional groups and a molecule having several alcohol groups (—OH), called polyol. The selection of the polyisocyanate and polyol give the polyurethane elastomeric or non-elastomeric properties. The selection of a thermoplastic elastomer of the polyurethane type contributes to an improved dynamic load-bearing capacity. The attachment of the thermoplastic polyurethane elastomer to the boundary surfaces of a fibre-reinforced thermoplastic panel and a metal plate with short links (monomer/oligomer) to form a 3-dimensional large mesh net, contributes to the elastomeric properties of the intermediate layer. This improves the dynamic load capacity.

The thermoplastic polyurethane elastomer can be an aromatic or aliphatic polyurethane elastomer. The functional groups, with which the reactive monomer/oligomer can react, can be hydroxyl and/or carboxyl groups. The thermoplastic polyurethane can be produced with a chain extender. Examples of chain extenders are amines or alcohols with at least two functional groups.

Appropriate diisocyanates as starting material are toluene diisocyanate (TDI), diphenylmethane diisocyanate (MDI), 1,5-naphthalene diisocyanate (NDI), tetramethyl xylene diisocyanate (TMXDI), isophorone diisocyanate (IPDI), 4,4′-bis-methylene cyclohexane diisocyanate (HMDI).

In the fibre-metal composite panel the thickness of the thermoplastic panel and the metal plate is preferably less than 3 mm. The metal plate preferably has a thickness of less than 1 mm. Preferably, the thickness of the metal plate is situated between 0.1 and 0.8 mm, more preferably between 0.2 and 0.5 mm.

The metal plate in the fibre-metal composite panel is preferably made of a material with a tensile strength of more than 350 N/mm2. The tensile test on metal is performed according to the ISO 6892-1 test method at room temperature. The tensile strength of a panel according to the present invention is measured according to DIN 53293 Testing of sandwiches, bending test, February 1982.

The metal plates in the fibre-metal composite panel are preferably made from an aluminium alloy; more preferably from an alloy selected from an aluminium-copper alloy or an aluminium-zinc alloy.

In an alternative preferred embodiment, a metal plate in the fibre-metal composite panel is formed from a titanium alloy or from steel.

Preferably, the fibre reinforcement is provided by fibres selected from: glass fibres, aramid fibres, carbon fibres, basalt fibres, polyethylene fibres, polyester fibres, polyamide fibres, ceramic fibres, steel fibres, vegetable fibres, or combinations thereof. Preferably glass fibres, aramid fibres or carbon fibres are used.

The thermoplastic panel in a fibre-metal composite panel according to a preferred embodiment of the invention is preferably fibre reinforced with wires formed from glass or polyaramid or carbon.

The monomer or oligomer in the chemical crosslinking agent is preferably an expoxyde, an aziridin, a carbodiimide, a polyisocyanate, a polyamine, a polyol or an ethylene vinyl acetate (EVA).

Preferably, the wires in the fibre-metal composite panel extend in two or more different directions. Preferably, fibre bundles lie at an angle of 90°.

In a second aspect, the invention provides a multilayer fibre-metal composite panel formed from two or more fibre-metal composite panels according to an embodiment of the invention.

Preferably, the number of metal plates in the multilayer fibre-metal composite panel is from 3 to 25. More preferably the number is 4 to 22, still more preferably 5 to 20, most preferably 10 to 15.

A composite element according to an embodiment of the invention can be used in various applications where replacement of traditional materials is desired.

In a third aspect, the invention provides a structural component for a vehicle, preferably a transportation vehicle or an aerospace vehicle, such as an aircraft, or a space vehicle, such as a shuttle or satellite. The structural part is made of a fibre-metal composite panel according to a preferred embodiment of the invention or of a multilayer fibre-metal composite panel according to a preferred embodiment of the invention. The structural part, for example a wing component, can provide savings in structural weight and increase the safety because of the use of a covalent bonding technique instead of glue. A composite panel according to an embodiment of the invention is also advantageously used in the nose of an aircraft.

In a fourth aspect, the invention provides a method for manufacturing a fibre-metal composite panel according to a preferred embodiment of the invention or a multilayer fibre-metal composite panel according to a preferred embodiment of the invention, in which a fibre-reinforced thermoplastic panel and a metal plate, between which a chemical crosslinking agent is applied, under application of a temperature below the melting temperature of the thermoplastic panel, the melting temperature of the thermoplastic polymer in the chemical crosslinking agent and the melting of one or more metal plates.

The term “melting temperature” as used herein, means the temperature at which the plastic melts.

Preferably the temperature is between 20° C.-120° C., including end points. More preferably the temperature is between 25° C. and 100° C., still more preferably the temperature is between 30° C. and 80° C., most preferably between 40° C. and 60° C. Being able to join the components of the composite panel at low temperatures has the advantage of an energy-efficient production. This is advantageous for the cost position of the production.

In another preferred embodiment, crosslinking is realized at room temperature of 20-25° C. This has the advantage that no heat supply is required.

The above method has the advantage that the process can be carried out at relatively low temperature. This is energy efficient and beneficial to the cost of the panel.

Preferably in the method, a thermoplastic panel and a metal plate, between which a chemical crosslinking agent is applied, are joined under application of external pressure. Preferably, the external pressure is at least 0.5 bar (50000 Pascal) and at most 5 bar (500000 Pascal). The use of pressure is advantageous for a good contact between the different materials. This is advantageous for a good bonding of the materials.

The method according to a preferred embodiment of the invention further comprises the following steps:
providing a thermoplastic panel a) comprising a boundary surface with at least one functional group rₐ),
providing a metal plate b), comprising a boundary surface with at least one functional group f_{b}, equal to or different from said functional group rₐ,
applying a chemical crosslinking composition c) to the boundary surface of the thermoplastic panel a) and the metal sheet b), the chemical crosslinking composition comprising
c1) a thermoplastic polymer with at least one functional group r_{c}), equal to or different from said functional group rₐ) and/or r_{b}), and
c2) a monomer or oligomer with at least two reactive functional groups r_{d1}), r_{d2}), preferably r_{d1})=r_{d2}), wherein r_{d1}) and r_{d2}) are selected for reactivity with the functional groups rₐ), r_{b}) and r_{c}),
reacting said at least two functional groups r_{d1}), r_{d2}) of the monomer or the oligomer with said functional groups rₐ), r_{b}), r_{c}), thereby crosslinking the boundary surface of the thermoplastic panel a), the boundary surface of the metal plate b) and the thermoplastic polyurethane elastomer c1) in the chemical crosslinking composition.

Said method has the advantage that chemical connections ensure that different layers are joined together. The chemical compounds have a covalent nature. Crosslinked layers and the built-in thermoplastic polyurethane elastomer ensure an improved resistance to delamination.

The thermoplastic panel a) is fibre-reinforced. Preferably, the fibre reinforcement is provided by glass fibres, aramid fibres, carbon fibres, basalt fibres, polyethylene fibres, polyester fibres, polyamide fibres, ceramic fibres, steel fibres, vegetable fibres, or combinations thereof. More preferably by glass fibres, aramid fibres, carbon fibres.

Preferably, the monomer or oligomer which is used in the method according to a preferred embodiment of the invention, is an epoxide, an aziridine, a carbodiimide, a polyisocyanate, a polyamine, a polyol or an ethylene vinyl acetate (EVA).

By the term oligomer as used herein is meant a chemical compound consisting of at least two units or monomers. The number of units is preferably less than 10, more preferably less than 5, most preferably less than 4.

The ratio of monomer or oligomer with respect to thermoplastic polyurethane elastomer is preferably between 95:1 and 1:95, more preferably between 80:20 and 20:80, expressed in weight of monomer or oligomer with respect to the weight of thermoplastic polyurethane elastomer (w/w).

Preferably, at least one functional group rₐ) and/or r_{b}) is selected from an OH group, a SH group, a NH group, a NH2 group, a carboxyl group.

Preferably, in the method according to a preferred embodiment of the invention, a polyamide in the thermoplastic panel a) is crosslinked with a thermoplastic polyurethane elastomer from composition c).

Preferably, the thermoplastic panel comprises a) polyamide chemically bonded to and (glass) fibres obtained from an impregnation and in-situ polymerization process of caprolactam and (glass) fibres.

Preferably, layer b) comprises a (glass) fibre content of at least 40% in weight, more preferably at least 50% in weight, still more preferably at least 60% in weight, most preferably at least 70% in weight.

A commercially available product which is preferably used as a thermoplastic panel in a method according to an embodiment of the invention are the thermoplastic Organosheets of the company Johns Manville. The Neomera™ organosheets are produced in a continuous process by the impregnation of tissues with a caprolactam monomer, followed by in situ anionic polymerization of caprolactam thereby forming a thermoplastic polyamide matrix.

Particularly advantageous is the use of a Neomera OS-6 or NCF-6 panel, a polyamide-6 thermoplastic organosheet with woven fabric impregnated with PA-6 resin. The fabrics can have a density of up to 2.500 g/m2. Combined with a metal plate and binding system according to the invention, this provides a fibre-reinforced thermoplastic-metal plate with high strength and stiffness. Shrinkage can also be controlled excellently.

Preferably, the metal plate is activated before the chemical crosslinking agent is applied. The activation can be done by cleaning the metal surface with a solution of hydrogen peroxide (H2O2). Preferably with a 1-15 w/w % aqueous solution H2O2. The concentration of H2O2 was preferably 3, 6 or 12 weight % in water. The inventor suspects that activation has the advantage of forming hydroxyl groups on the metal surface. These are reactive with the monomer/oligomer in the composition for chemical crosslinking.

Composition c) is preferably applied in liquid form. This is a comfortable way of applying a composition. This method can easily be applied on a large scale.

More preferably, c) the liquid composition has a viscosity situated between 100 and 3000 mPa·s, more preferably between 500 and 2500 mPa·s, still more preferably between 1000 and 2300 mPa·s, most preferably between 1500 and 2200 mPa·s, measured at 20° C. The viscosity is selected to have a good flowing composition that allows machine processing. The viscosity is measured according to standard ISO 1628-1:2021.

The viscosity is preferably chosen to allow spreading of the composition in a thin layer. At the same time, the composition is preferably not so fluid that the composition is unavailable for binding and runs off when a layer is manipulated. If desired, thickeners can be added to increase the viscosity. An example of a suitable thickener is bentonite or starch.

The liquid composition c) is preferably substantially free of water. The term substantially free of water means a water content below 5%. Preferably, the water content is below 1%, more preferably below 0.5%, most preferably below 0.1%. The water content of the liquid composition c) can be determined with a Karl Fisher water titration. The presence of water is kept low to avoid foaming.

The liquid composition c) is preferably a solvent-based composition. By a solvent is meant a solvent that is not water. A solvent suitable for use in the present invention is methylethylketone (MEK).

Preferably, the liquid composition c) comprises less than 30% of solvent. More preferably, less than 20%, still more preferably less than 10%, most preferably less than 5% of solvent is used. The amount of solvent is expressed in volume of solvent with respect to the total volume of solvent, monomer/oligomer and thermoplastic polymer. This ensures a good proximity of the c1) and c2) components.

In an alternative preferred embodiment, composition c) is applied in the form of a powder. Preferably, the components c1) and c2) are mixed well before they are used in a method according to an embodiment of the invention.

In an alternative preferred embodiment, composition c) is applied in the form of a film. A film can for example be obtained as follows: mixing c1) en c2) both in a solid state; spreading the powder mixture followed by heating the powder mixture; forming a liquid or sintered layer; cooling the layer with the formation of a film.

Most preferably, c2) is a diisocyanate or polyisocyanate. This monomer has an excellent reactivity.

Preferably, the composition c) is applied in an amount of 100 g/m²-1000 g/m². More preferably, the composition c) is applied in an amount of 100-500 g/m², still more preferably 150-450 g/m², most preferably 200-400 g/m². A low material consumption is economically interesting.

Preferably, the fibre-reinforced thermoplastic panel is obtained by impregnating a fabric with a caprolactam monomer, followed by in situ anionic polymerization of caprolactam thereby forming a thermoplastic polyamide matrix. The viscosity should be sufficiently low to be able to impregnate the fabric.

In a further aspect, the invention provides a multilayer fibre-metal composite panel manufactured according to an embodiment of the method according to the invention, the composite panel comprising a thermoplastic panel a) and a metal plate b) wherein a boundary surface of the thermoplastic panel a) is chemically crosslinked with a boundary surface of the metal plate b), by means of a chemical crosslinking composition c) comprising a thermoplastic polyurethane elastomer and a monomer or oligomer for crosslinking a), b) and c).

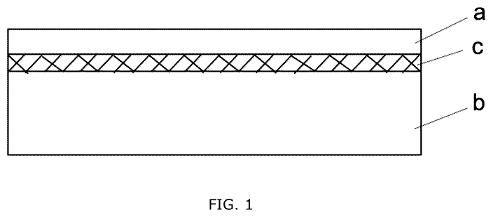

The invention is further illustrated by a number of examples. These are non-limiting. Preferred embodiments of the invention are illustrated in FIG. 1.

### Preferred Embodiments

1. A fibre-metal composite panel formed from a thermoplastic panel and a metal plate, characterized in that the thermoplastic panel and the metal plate are bonded using a chemical crosslinking agent, and the thermoplastic panel is fibre-reinforced.

2. The fibre-metal composite panel according to preferred embodiment 1, comprising at least one fibre substrate and at least one thermoplastic polymer P1 coupled to the fibre substrate; the fibre substrate is preferably a glass fibre substrate.

3. The fibre-metal composite panel according to preferred embodiment 1 or 2, characterized in that the chemical crosslinking agent comprises:
c1) a thermoplastic polymer P2 having at least one functional group r_{c}), in which thermoplastic polymer P2 is a thermoplastic polyurethane elastomer,
c2) a monomer or oligomer with at least two reactive functional groups r_{d1}), r_{d2}),
in which r_{d1}) and r_{d2}) are selected for reactivity with
a functional group rₐ) of the thermoplastic panel,
a functional group r_{b}) of the metal plate and
a functional group r_{c}) of the thermoplastic polymer P2 in the chemical crosslinking agent.

4. The fibre-metal composite panel according to preferred embodiment 3, characterized in that the functional group r_{c}), is equal to or different from aforementioned functional groups rₐ) and/or r_{b})

5. The fibre-metal composite panel according to preferred embodiment 2 or 3, characterized in that r_{d1})=r_{d2}).

6. The fibre-metal composite panel according to one of the preferred embodiments 1 to 5, characterized in that the thermoplastic panel and the metal plate each have a thickness, which is less than 3 mm.

7. The fibre-metal composite panel according to one of the preferred embodiments 1 to 6, characterized in that the metal plate has a thickness which is less than 1 mm, preferably a thickness of 0.1 to 0.8 mm, more preferably 0.2 to 0.5 mm.

8. The fibre-metal composite panel according to one of the preferred embodiments 1 to 7, characterized in that the metal plate is made of a material with a tensile strength of more than 350 N/mm2.

9. The fibre-metal composite panel according to one of the preferred embodiments 1 to 8, characterized in that the metal plates are made of an aluminium alloy; more preferably of an alloy selected from an aluminium-copper alloy or an aluminium-zinc alloy.

10. The fibre-metal composite panel according to one of the preferred embodiments 1 to 9, characterized in that the metal plate is made of a titanium alloy or steel.

11. The fibre-metal composite panel according to one of the preferred embodiments 1 to 10, characterized in that the thermoplastic panel is reinforced with wires made of glass or polyaramid of carbon.

12. The fibre-metal composite panel according to one of the preferred embodiments 1 to 11, characterized in that the monomer or oligomer is an epoxide, an aziridine, a carbodiimide, a polyisocyanate, a polyamine, a polyol or an ethylene vinyl acetate (EVA).

13. The fibre-metal composite panel according to one of the preferred embodiments 1 to 12, characterized in that the wires extend in two or more different directions; preferably the panel comprises a woven wire fabric.

14. A multilayer fibre-metal composite panel formed from two or more laminates according to one of the preferred embodiments 1 to 13.

15. The multilayer fibre-metal composite panel according to preferred embodiment 14, characterized in that the number of metal plates is 3 to 25.

16. A structural part for a vehicle, characterized in that the structural part is made of a fibre-metal composite panel according to any one of the conclusions 1 to 13 or of a multilayer fibre-metal composite panel according to preferred embodiment 14 of 15.

17. The structural part for a vehicle according to preferred embodiment 16, characterized in that the vehicle is a spacecraft or aircraft.

18. A method for manufacturing a fibre-metal composite panel according to any of the previous preferred embodiments 1 to 13 or a multilayer fibre-metal composite panel according to preferred embodiment 14 or 15, in which a thermoplastic panel and a metal plate, between which a chemical crosslinking agent is applied, are adhered by applying a temperature below the melting temperature of the thermoplastic panel, the melting temperature of the thermoplastic polymer in the chemical crosslinking agent and the melting of one or more metal plates; preferably the temperature is between 20° C.-120° C., including end points.

19. The method of preferred embodiment 18, characterized in that a thermoplastic panel and a metal plate, between which a chemical crosslinking agent is applied, are attached to each other under application of an external pressure; preferably the external pressure is at least 0.5 bar (50000 Pascal) and at most 5 bar (500000 Pascal).

20. The method of preferred embodiments 18 or 19, comprising the following steps:
providing a thermoplastic panel a) comprising a boundary surface with at least one functional group rₐ),
providing a metal plate b), comprising a boundary surface with at least one functional group f_{b}, equal to or different from said functional group rₐ),
applying a chemical crosslinking composition c) to the boundary surface of the thermoplastic panel a) and the metal sheet b), the chemical crosslinking composition comprising
c1) a thermoplastic polymer with at least one functional group r_{c}), equal to or different from said functional group rₐ) and/or r_{b}), in which the thermoplastic polymer is a thermoplastic polyurethane elastomer, and
c2) a monomer or oligomer with at least two reactive functional groups r_{d1}), r_{d2}), preferably r_{d1})=r_{d2}), wherein r_{d1}) and r_{d2}) are selected for reactivity with the functional groups rₐ), r_{b}) and r_{c}),
reacting said at least two functional groups r_{d1}), r_{d2}) of the monomer or the oligomer with said functional groups rₐ), r_{b}), r_{c}), thereby crosslinking the boundary surface of the thermoplastic panel a), the boundary surface of the metal plate b) and the thermoplastic polyurethane elastomer c1) in the chemical crosslinking composition; and in which said thermoplastic panel a) is fibre-reinforced; preferably the fibre reinforcement is provided by glass fibres, aramid fibres, carbon fibres.

21. The method according to any one of preferred embodiments 18 to 20, wherein the monomer or oligomer is an epoxide, an aziridine, a carbodiimide, a polyisocyanate, a polyamine, a polyol or an ethylene vinyl acetate (EVA).

22. The method according to any of the previous preferred embodiments 18 to 21, wherein at least one functional group rₐ) and/or r_{b}) is selected from an OH group, an SH group, an NH group, an NH2 group, a carboxylic group.

23. The method according to any one of preferred embodiments 18 to 22, wherein a polyamide in the thermoplastic panel a) is crosslinked with a thermoplastic polyurethane elastomer of composition c).

24. The method according to any one of the previous preferred embodiments 18 to 23, in which the fibre-reinforced thermoplastic panel is obtained by impregnating a glass fibre fabric with a caprolactam monomer, followed by in situ anionic polymerization of caprolactam thereby forming a glass fibre reinforced thermoplastic polyamide matrix.

25. The method according to any one of the previous preferred embodiments 18 to 24, in which the metal plate is activated on a surface before the chemical crosslinking agent is applied to said surface; preferably the surface of the metal plate is activated with hydrogen peroxide.

26. A multilayer fibre-metal composite panel manufactured according to the method of one or more of the preferred embodiments 18 to 25, the composite panel comprising a thermoplastic panel a) and a metal plate b) wherein a boundary surface of the thermoplastic panel a) is crosslinked with a boundary surface of the metal plate b), by means of a chemical crosslinking composition c) comprising a thermoplastic polyurethane elastomer and a monomer or oligomer for crosslinking a), b) and c).

### EXAMPLES

### Example 1

FIG. 1 is a schematic representation of a composite element obtained according to a method of the invention. A glass fibre reinforced polyamide panel b obtained by Johns Manville with trade name Neomera™ was treated with MEK and then coated with a liquid composition c comprising a thermoplastic polyurethane elastomer c1 and a diisocyanate c2.

An aluminium panel a was activated with a 12% aqueous hydrogen peroxide solution. Subsequently, the same crosslinking composition was applied to the metal surface.

Panel a and b were turned towards each other. The liquid compositions were placed on top of each other. The resulting layered composite panel was stored for 24 hours before use.

After 24 hours, a delamination test was performed. The metal and thermoplastic panel did not come loose.

### Example 2

In an additional experiment, a multilayer fibre-metal composite panel was formed, according to the procedure from Example 1.

An aluminium plate was connected to a fibreglass-reinforced polyamide panel. At the opposite surface to the aluminium plate, the polyamide panel was again connected to an aluminium plate. The aluminium plate was reconnected to a fibreglass-reinforced polyamide panel.

The procedure was repeated until a composite panel was obtained with 10 aluminium layers and 10 fibreglass-reinforced polyamide layers, in which the polyamide is chemically bonded to the glass fibres.

After 24 hours, a delamination test was performed. There was no delamination.

1.-25. (canceled)

26. A fibre-metal composite panel formed from a thermoplastic panel and a metal plate, in which the thermoplastic panel and the metal plate are bonded by means of a chemical crosslinking agent, and the thermoplastic panel is fibre-reinforced,
wherein the chemical crosslinking agent comprises a thermoplastic polyurethane elastomer.

27. The fibre-metal composite panel according to claim 26, comprising at least one fibre substrate and at least one thermoplastic polymer P1 coupled to the fibre substrate; the fibre substrate is a glass fibre substrate.

28. The fibre-metal composite panel according to claim 26, wherein the chemical crosslinking agent comprises:
c1) a thermoplastic polymer P2 having at least one functional group rc), in which thermoplastic polymer P2 is a thermoplastic polyurethane elastomer,
c2) a monomer or oligomer with at least two reactive functional groups rd1), rd2),
in which rd1) and rd2) are selected for reactivity with
a functional group ra) of the thermoplastic panel,
a functional group rb) of the metal plate and
a functional group rc) of the thermoplastic polymer P2 in the chemical crosslinking agent.

29. The fibre-metal composite panel according claim 28, wherein the functional group rc), is equal to or different from aforementioned functional groups ra) and/or rb).

30. The fibre-metal composite panel according to claim 28, wherein rd1)=rd2).

31. The fibre-metal composite panel according to claim 26, wherein the thermoplastic panel and the metal plate each have a thickness, which is less than 3 mm.

32. The fibre-metal composite panel according to claim 26, wherein the metal plate has a thickness which is less than 1 mm.

33. The fibre-metal composite panel according to claim 26, wherein the metal plates are made of an aluminium alloy.

34. The fibre-metal composite panel according to claim 26, wherein the metal plate is made of a titanium alloy or steel.

35. The fibre-metal composite panel according to claim 26, wherein the thermoplastic panel is reinforced with wires made of glass or polyaramid or carbon.

36. The fibre-metal composite panel according to claim 26, wherein the monomer or oligomer is an epoxide, an aziridine, a carbodiimide, a polyisocyanate, a polyamine, a polyol or an ethylene vinyl acetate (EVA).

37. The fibre-metal composite panel according to claim 26, wherein the wires extend in two or more different directions; the panel comprises a woven wire fabric.

38. A multilayer fibre-metal composite panel formed from two or more laminates according to claim 26.

39. The multilayer fibre-metal composite panel according claim 38, wherein the number of metal plates is 3 to 25.

40. A structural part for a vehicle, wherein the structural part is made of a fibre-metal composite panel or a multilayer fibre-metal composite panel according to claim 38.

41. The structural part for a vehicle according to claim 40, wherein the vehicle is a spacecraft or aircraft.

42. A method for manufacturing a fibre-metal composite panel or a multilayer fibre-metal composite panel according to claim 38, in which a thermoplastic panel and a metal plate, between which a chemical crosslinking agent is applied, are adhered by applying a temperature below the melting temperature of the thermoplastic panel, the melting temperature of the thermoplastic polymer in the chemical crosslinking agent and the melting of one or more metal plates; the temperature is between 20° C.-120° C., including end points,
wherein the chemical crosslinking agent comprises a thermoplastic polyurethane elastomer.

43. The method according to claim 42, wherein a thermoplastic panel and a metal plate, between which a chemical crosslinking agent is applied, are attached to each other under application of an external pressure; the external pressure is at least 0.5 bar (50000 Pascal) and at most 5 bar (500000 Pascal).

44. The method according to claim 42, additionally comprising the following steps:
providing a thermoplastic panel a) comprising a boundary surface with at least one functional group ra),
providing a second metal plate b), comprising a boundary surface with at least one functional group fb, equal to or different from said functional group ra),
applying a chemical crosslinking composition c) to the boundary surface of the thermoplastic panel a) and the metal sheet b), the chemical crosslinking composition comprising
c1) a thermoplastic polymer with at least one functional group rc), equal to or different from said functional group ra) and/or rb), in which the thermoplastic polymer is a thermoplastic polyurethane elastomer, and
c2) a monomer or oligomer with at least two reactive functional groups rd1), rd2), wherein rd1) and rd2) are selected for reactivity with the functional groups ra), rb) and rc),
reacting said at least two functional groups rd1), rd2) of the monomer or the oligomer with said functional groups ra), rb), rc), thereby crosslinking the boundary surface of the thermoplastic panel a), the boundary surface of the metal plate b) and the thermoplastic polyurethane elastomer c1) in the chemical crosslinking composition; and in which said thermoplastic panel a) is fibre-reinforced; the fibre reinforcement is provided by glass fibres, aramid fibres, carbon fibres.

45. The method according to claim 42, wherein the monomer or oligomer is an epoxide, an aziridine, a carbodiimide, a polyisocyanate, a polyamine, a polyol or an ethylene vinyl acetate (EVA).

46. The method according to claim 42, wherein at least one functional group ra) and/or rb) is selected from an OH group, an SH group, an NH group, an NH2 group, a carboxylic group.

47. The method according to claim 42, wherein a polyamide in the thermoplastic panel a) is crosslinked with a thermoplastic polyurethane elastomer of composition c).

48. The method according to claim 42, in which the fibre-reinforced thermoplastic panel is obtained by impregnating a glass fibre fabric with a caprolactam monomer, followed by in situ anionic polymerization of caprolactam thereby forming a glass fibre reinforced thermoplastic polyamide matrix.

49. The method according to claim 42, in which the metal plate is activated on a surface before the chemical crosslinking agent is applied to said surface; the surface of the metal plate is activated with hydrogen peroxide.

50. A multilayer fibre-metal composite panel manufactured according to the method of claim 42, the composite panel comprising a thermoplastic panel a) and a metal plate b)
wherein a boundary surface of the thermoplastic panel a) is crosslinked with a boundary surface of the metal plate b), by means of a chemical crosslinking composition c) comprising a thermoplastic polyurethane elastomer and a monomer or oligomer for crosslinking a), b) and c).
